(19) United States
(12) Patent Application Publication
(10) Pub. No.: US 2005/0115345 A1
(43) Pub. Date: Jun. 2, 2005

(54) Transmission with particular transmission shafts

(76) Inventors: Gerhard Gumpoltsberger, Friedrichshafen (DE); Frank Linke, Brandenburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/946,532

(22) Filed: Sep. 21, 2004

(30) Foreign Application Priority Data
Sep. 23, 2003 (DE) 103 43 991.9

(51) Int. Cl. F16H 3/08

(52) U.S. Cl. 74/331

(57) ABSTRACT

A transmission having one starting and/or gear clutch, the input side is connected with one drive shaft of a prime mover and the output side (8) with a transmission input shaft; one countershaft is supported or fastened speed gear wheels designed as idler gears or as fixed gears which mesh with speed gear wheels non-rotatably situated upon the transmission input shaft and designed as fixed gears or rotatably supported and designed as idler gears, and shifting sets, which for connecting the idler gears with the respectively coordinates shaft, are non-rotatably and axially movably supported upon the shaft and axially movable there via setting devices. For reducing the development, production and storage costs in transmissions of similar design, the transmission input shaft is comprised of at least two non-rotatably interconnected part shafts.

According to the preamble of claim 1, the invention relates to a transmission for a motor vehicle.

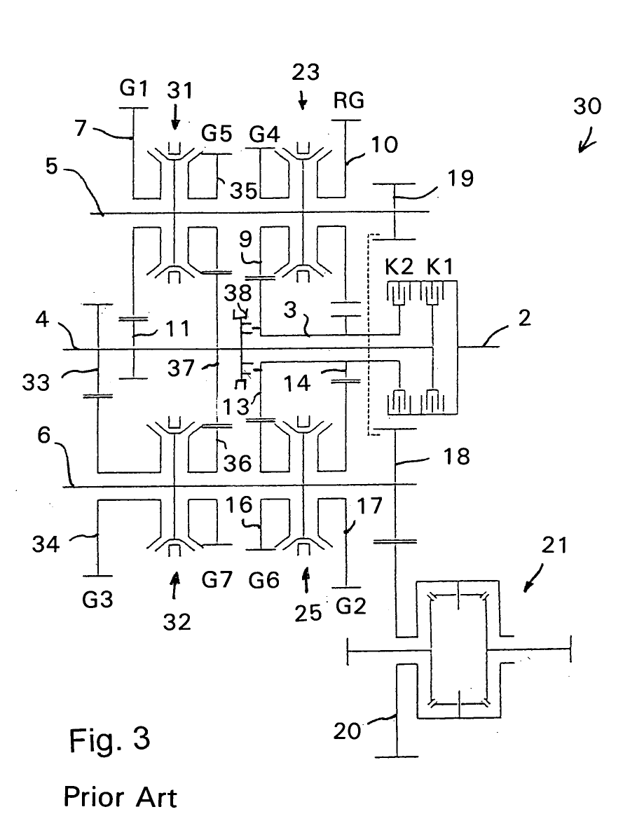

The pre-published German patent application DE 103 05 241 A1 shows a dual-clutch transmission 30 (FIG. 3) where the input sides of both clutches K1, K2 of the dual-clutch are connected with a drive shaft 2 of a prime mover (not shown).

The output sides of the two clutches K1, K2 are non-rotatably connected with two transmission input shafts of which one input shaft 3 is designed as hollow shaft and in which the second input shaft 4 is coaxially accommodated and rotatably supported.

To form transmission speeds, upon the two input shafts 3, 4 fixed gear wheels 11, 13, 14, 44, 37 are situated, which are rotatably supported with idler gears 7, 9, 10, 35 on a first countershaft 5 and with idler gears 16, 17, 34, 36 upon a second countershaft 6.

A reverse gear shaft having one reverse gear wheel (not shown), which for reversal of direction or rotation meshes with the fixed gear 14 and the reverse gear idler gear 10.

The transmission 30 further has available upon both paraxial countershafts 5, 6, so-called shifting sets 23, 25, 31, 32 with synchronizer rings and sliding sleeves which, by actuation devices (not shown), are axially displaceable upon the countershafts 5, 6 for non-rotatable connection of the latter with the idler gears.

Besides, one output gear wheel 18, 19 is fastened on each one of the two countershafts 5, 6 and meshes with a toothing 20 on a differential transmission 21.

This dual-clutch transmission 30 further has available one other coupling device 38 by means of which the two transmission input shafts 5, 6 can be optionally non-rotatably interconnected.

Finally the gear sequence in the dual-clutch transmission 30, starting from the two clutches K1 and K2 of the dual clutch, is as follows: reverse gear RG and second gear G2; fourth gear G4 and sixth gear G6; fifth gear G5 and seventh gear G7; first gear G1 and third gear G3.

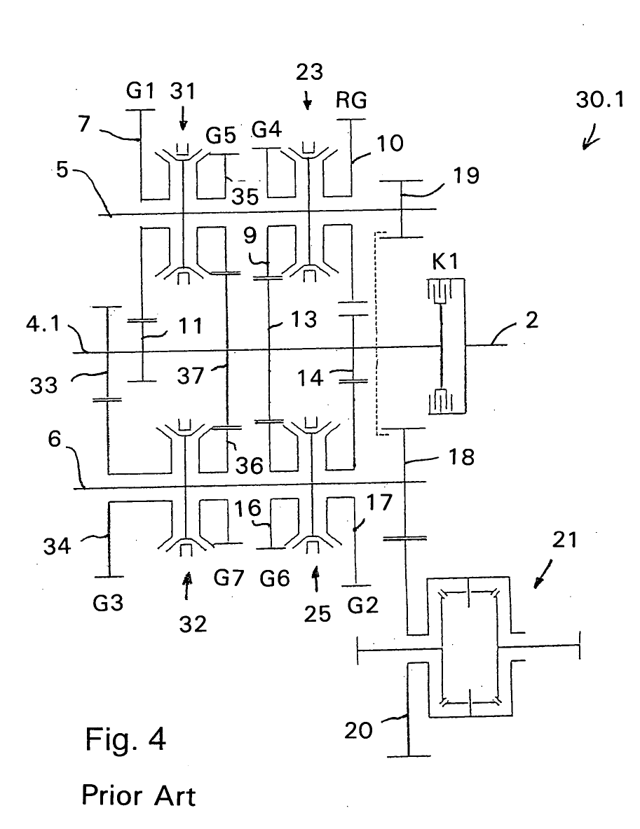

A transmission 30.1 is derived from this dual-clutch transmission shown in FIG. 4, having only one starting gear clutch K1, which is not known from the pre-published German patent application DE 103 05 242 A1. As shown by a comparison between the two transmissions according to FIGS. 3 and 4, both are, to a great extent, identically designed so that considerable savings in cost are possible in the development, production and storage of transmission parts both of the dual-clutch transmission and of the transmission.

Let it be only marginally observed that the transmission 30.1, according to FIG. 4, despite the immediately adjacent arrangement of each two non consecutive transmission gears in an H-gate, can be shifted without problem when using a conversion device for the purpose, such as disclosed in the unpublished DE 102 31 547 A1.

As shown by the comparison between the two transmissions of FIG. 3 and FIG. 4, the essential difference between them is that the dual-clutch transmission 30 has two input shafts 3, 4 available, while the transmission 30.1 of FIG. 4 has only one transmission input shaft 4.1 connected with the output side of the clutch K1 and upon which are fastened all input-side fixed gears 11, 13, 14, 33, 37 of the transmission 30.1. For this reason, the transmission input shaft 4.1 has to be separately laid out, produced and stored as a single part of the two transmissions 30, 30.1, which increases the development, production and storage costs.

Against this background, the problem on which the invention is based is to introduce a technical solution, especially for the described mechanical assembly, a principle for production of a dual-clutch transmission and of a transmission having only one starting and gear clutch by which further savings in cost can be obtained regarding the different transmission input shafts.

The solution of the problem results from the features of the main claim while advantageous developments and embodiments of the invention can be understood from the sub-claims.

The invention departs from a transmission having one starting and/or gear clutch, the input side of which is connected with one drive shaft of a prime mover and the output side with one transmission input shaft upon which fixed gears are fastened. The transmission has further available at least one countershaft upon which are rotatably supported or fastened gear wheels designed as idler gears or as fixed gears situated and designed as fixed gears or rotatably supported and designed as idler gears, and shifting sets which, for connecting the idler gears with the respectively coordinated shaft, are non-rotatably and axially moveably supported on the shaft and are there axially movable by way of setting devices.

To solve the stated problem it is provided in this transmission that the input shaft be comprised of at least two non-rotatably interconnected part shafts.

In development of this inventive basic principle, it can be provided that the part shafts be interconnected with positive fit or frictional engagement by shaft couplings, heat shrinking or thermal jointing process.

In a special embodiment of the invention, the part shafts can be designed as full shafts joined to each other by their respective front sides.

Another alternative of the non-rotatable connection between the part shafts can determine that the part shafts be interconnected by means of axial or radial plug-in toothings.

According to another development of the invention, one of the part shafts can be designed as a full shaft and another part shaft as a hollow shaft with the full shaft being non-rotatably accommodated in the hollow shaft. In addition, the hollow shaft used construction can also be used in building a dual-clutch transmission.

In this connection, it is deemed convenient that the idler and fixed gears, as well as the coupling devices, situated on the part shafts have the same design and be arranged in the same sequence in the transmission as in a dual-clutch transmission.

For using at least one full shaft of the transmission also in a dual-clutch transmission, it is preferably provided that in its end facing the clutch, the shaft is made shorter in comparison with the full shaft of the dual-clutch transmission.

In addition, compared to the hollow shaft of the dual-clutch transmission, it is advantageous that the hollow shaft of the transmission has a reduced internal diameter and/or a plug-in toothing so that the full shaft can be accommodated therein in force-locking and/or positive fit manner.

In addition, it can be provided that at least one full shaft has axial and/or radial bores available to reduce the weight and/or to design pressure medium lines.

The inventive construction principle is not basically limited to transmissions having two countershafts. On the contrary, the design can also be used in transmissions having only one countershaft preferably paraxial with the transmission input shaft.

For better understanding of the invention, the description is accompanied by one drawing which shows:

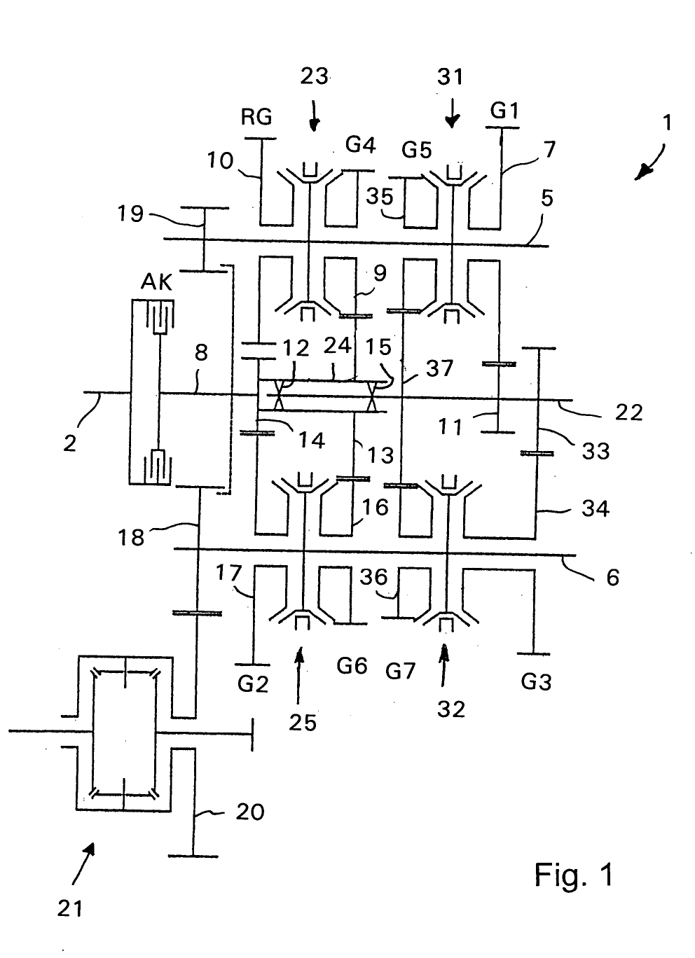

FIG. 1 is a diagrammatic representation of a seven-speed transmission;

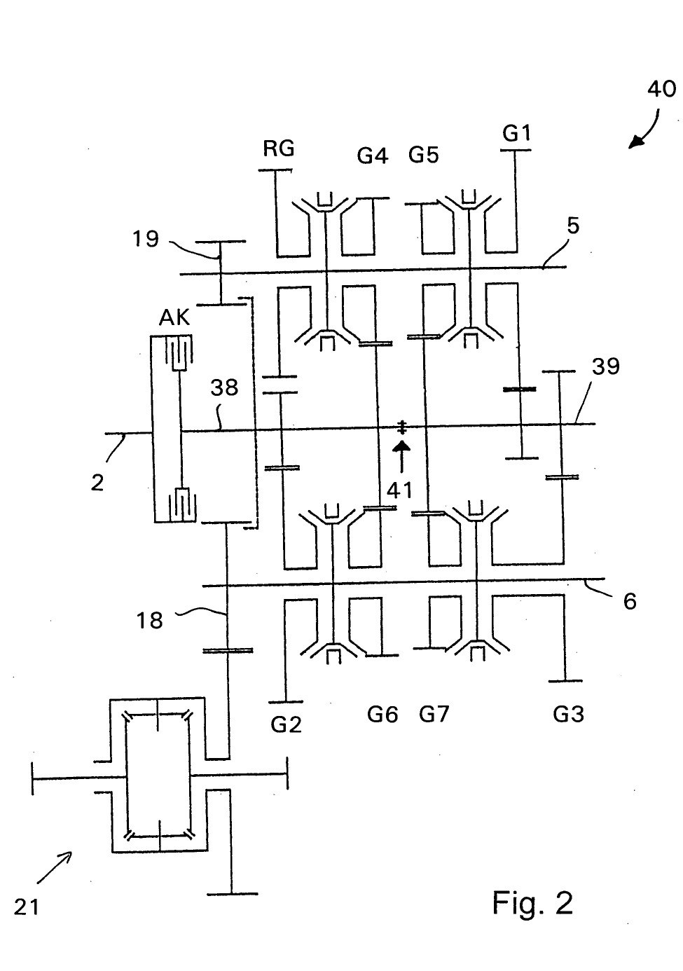

FIG. 2 is an alternative to the transmission according to FIG. 1;

FIG. 3 is an already known dual-clutch transmission; and

FIG. 4 is a seven-speed transmission according to the prior art.

For better orientation in the above mentioned Figures, in prior art transmissions and in the inventive transmissions, the same reference numerals have been given to the same parts of the transmission. The features of the transmission, according to the prior art already explained above (FIG. 3 and FIG. 4), will not be repeated herebelow but will be referred to.

As can now be understood from FIG. 1, the shaft arrangement and speed sequence of an inventively designed transmission 1 are quite similar to the design of the already known transmission of FIG. 3 and FIG. 4. The latter, thus has in the first place, one starting and gear clutch AK the input side of which is connected width a drive shaft 2 of a prime mover.

In this embodiment, an output side 8 of the clutch AK is connected via a short section with a transmission input shaft 22, 24 paraxially with which two countershafts 5, 6 are disposed. But the transmission input shaft 24 can also be directly and non-rotatably connected with the output side of the clutch AK

Upon the two countershafts 5, 6 are rotatably supported idler gears 7, 9, 10, 16, 17, 34, 35, 36 of the seven forward speeds and of the reverse speed, which can be driven by the gear wheels (fixed gears) 11, 13, 14, 33, 37 fastened on the transmission input shaft 22, 24.

On the ends pointing to the clutch AK of the two countershafts 5, 6, output gear wheels 18, 19 are fastened, which are meshed with a toothing 20 of an axle-differential transmission 21 so that the latter can be driven by the two countershafts 5, 6.

The arrangement or distribution of the idler and fixed gears on the transmission shafts is not critical for utilization of the advantages resulting from the invention.

In comparison with the known vehicle transmission, it is possible to achieve a development, production and storage of parts of more favorable cost. According to the core idea of the invention, it is provided, that the single transmission input shaft consists of two non-rotatably interconnected part shafts 22 and 24 which, with regard to the arrangement and design of said fixed gears 11, 13, 14, 33, 37, could be likewise used in a dual-clutch transmission 30 (FIG. 3) with only slight changes.

As made clear by a comparison of these two transmissions 1 and 30, according to FIG. 1 and FIG. 3 and according to the principle on which the invention is based, it is not necessary to provide as separate, a transmission input shaft 4.1 like in the known transmission according to FIG. 4. On the contrary, the transmission 1, according to FIG. 1, uses a hollow shaft 24 as a first transmission input shaft which, in the dual-clutch transmission 30, is provided with the reference numeral 3. Although in this embodiment, the section close to the clutch in the hollow shaft 24, compared with the hollow shaft 3, has been shortened by a portion for saving weight; the other construction and dimensions thereof are identical to a great extent.

In this hollow shaft 24, the second transmission input shaft 22 is un-rotatably supported which, unlike the transmission input shaft 4 of the dual-clutch transmission 30, has also been shortened by a portion close to the clutch which is indicated by a connecting means 12, 15.

With regard to the arrangement and design of the speed fixed gears, the same as of its own design and other dimensions, the second transmission input shaft 22 preferably has the same design as the transmission input shaft 4 of the known dual-clutch transmission 30 according to FIG. 3.

The connection of the two transmission input shafts 22, 24 can be detachable even if for some cases an undetachable connection is preferred. This connection can also be a friction engaged or positive fit connection. In a detachable connection, for example, a plug-in toothing with axial or radial toothing means, is preferred.

In development of the invention, it can be convenient that the hollow shaft 24 has a smaller internal diameter when compared to the transmission input shaft 3 designed as a hollow shaft of the known dual-clutch transmission 30 according to FIG. 3.

The above mentioned shaft connection, together with the possibility of using the transmission input shafts used in the dual-clutch transmission 30, has the added advantage that the bending torques acting upon one transmission inputs shaft, can mechanically and favorably be transferred to the other transmission input shaft.

Another alternative of the invention is shown in FIG. 2. A transmission 40 also uses the shaft arrangement and speed sequence of the known transmissions 30, 30.1, according to FIG. 3 and FIG. 4, but differs therefrom in that only one transmission input shaft is provided, which is composed of two part shafts 38, 39.

While the first part shaft 38 is non-rotatably connected with the output side of the starting and gear clutch AK and to that extent corresponds to the first section of the single transmission input shaft 4.1 of the known transmission 30.1 (FIG. 4), the second part shaft 39 consists of the second input shaft 4, designed as full shaft of the known dual-clutch transmission 30 according to FIG. 3, which is only shortened by the section close to the clutch which in this dual-clutch transmission 30 is supported in the first transmission input shaft 3.

The two part shafts 38, 39 are preferably designed as full shafts, the same as in positive fit and/or friction engagement manner interconnected respectively by one of their front sides by a shaft coupling, heat shrinking or thermal jointing process (welding, soldering, etc.). A connection 41 can also be designed as plug-in toothing. But finally one clutch can also be situated between the two part shafts 38, 39.

Covered by the invention is the use of the construction principle thereof in transmissions having only one countershaft or more than two countershafts. In each case, the transmission input shaft consists of two part shafts which, even if with slight modifications, can also be used in the dual-clutch transmission 30 (FIG. 3).

The comparison and embodiments used have made clear that by appropriate use of transmission parts of similar or different transmission types, it is possible to obtain clear advantages in cost in the development, production and storage of transmission parts.

Reference Numerals

| | |
|---|---|
| 1 | transmission |
| 2 | drive shaft |
| 3 | transmission input shaft, hollow shaft |
| 4 | transmission input shaft, full shaft |
| 4.1 | transmission input shaft |
| 5 | first countershaft |
| 6 | second countershaft |
| 7 | idler gear |
| 8 | output side of the clutch AK |
| 9 | idler gear |
| 10 | reverse gear idler gear |
| 11 | fixed gear |
| 12 | connecting means |
| 13 | fixed gear |
| 14 | fixed gear |
| 15 | connecting means |
| 16 | idler gear |
| 17 | idler gear |
| 18 | output gear wheel |
| 19 | output gear wheel |
| 20 | toothing on differential transmission |
| 21 | differential transmission |
| 22 | transmission input shaft, full shaft |
| 23 | shifting set |
| 24 | transmission input shaft, hollow shaft |
| 25 | shifting set |
| 30 | dual-clutch transmission (prior art) |
| 30.1 | transmission (prior art) |
| 31 | shifting set |
| 32 | shifting set |
| 33 | fixed gear |
| 34 | idler gear |
| 35 | idler gear |
| 36 | idler gear |
| 37 | fixed gear |
| 38 | part shaft |
| 39 | part shaft |
| 40 | transmission |
| 41 | shaft connection |
| AK | starting and gear clutch |
| G1 | first gear |
| G2 | second gear |
| G3 | third gear |
| G4 | fourth gear |
| G5 | fifth gear |
| G6 | sixth gear |
| G7 | seventh gear |
| RG | reverse gear |
| K1 | clutch |
| K2 | clutch |

1-10. (canceled)

11. A transmission (1, 40) having one starting and a gear clutch (AK), an input side of which is connected with a drive shaft (2) of a prime mover and an output side (8) with a transmission input shaft, at least one countershaft (5, 6) upon which are one of rotatably supported or fastened speed gear wheels designed as one of idler gears (7, 9, 10, 16, 17, 34, 35, 36) or as fixed gears which mesh with speed gear wheels non-rotatably situated upon the transmission input shaft and designed as one of fixed gears (11, 13, 14, 33, 37) or rotatably supported and designed as idler gears, and shifting sets (23, 25, 31, 32) which for connecting the idler gears with the respectively coordinated shaft, are non-rotatably and axially movably supported on the respectively coordinated shaft and are there axially movable by means of setting devices, the input shaft comprises at least two non-rotatably interconnected part shafts (22, 24; 38, 39).

12. The transmission according to claim 11, wherein the part shafts (22, 24; 38, 39) are interconnected in one of a positive fit or a friction engagement manner by one of shaft couplings, a heat shrinking or a thermal jointing process.

13. The transmission according to claim 11, wherein the part shafts are designed as full shafts (38, 39) which are joined to each other on one of their front sides.

14. The transmission according to claim 11, wherein the part shafts (22, 24; 38, 39) are interconnected by means of one of axial or radial plug-in toothings.

15. The transmission according to claim 11, wherein one of the part shafts is designed as a full shaft (22) and another part shaft as a hollow shaft (24) and the full shaft (22) is non-rotatably accommodated in the hollow shaft (24).

16. The transmission according to claim 11, wherein the gear wheels (11, 13, 14, 37) disposed upon the part shafts (22, 24; 38, 39), the same as coupling devices (22, 23, 24, 25, 31, 32), can be installed in a same construction, the same as in the same sequence, in the transmission (1, 40) and in one dual-clutch transmission (30).

17. The transmission according to claim 16, wherein at least one full shaft (22, 38, 39) of the transmission (1, 40), on an end facing the clutch (AK), is shortened compared with the transmission input shaft (4) designed as a full shaft of a dual-clutch transmission (30).

18. The transmission according to claim 16, wherein a hollow shaft (24) of the transmission (1, 40), compared with a hollow shaft (3) of the dual-clutch transmission (30), has one or more of a reduced internal diameter and a plug-in toothing.

19. The transmission according to claim 11, wherein at least one full shaft (22, 24, 38, 39) has one or more available axial and radial bores.

20. The transmission according to claim 11, wherein the transmission is designed as countershaft transmission (1, 40) with one or more countershafts (5, 6).
